(19) United States
(12) Patent Application Publication
(10) Pub. No.: US 2007/0199793 A1
(43) Pub. Date: Aug. 30, 2007

(54) Motor driven ball and ramp clutching system for a marine transmission

(76) Inventor: George Reisch Aschauer, Bemidji, MN (US)

Correspondence Address: GEORGE REISCH ASCHAUER, 2214 RED OAK CT. NE, BEMIDJI, MN, 56601, US

(21) Appl. No.: 11/639,056

(22) Filed: Dec. 15, 2006

Related U.S. Application Data
(63) Continuation-in-part of application No. 11/364,783, filed on Feb. 27, 2006.

(51) Int. Cl. F16D 28/00

(52) U.S. Cl. 192/84.6; 192/84.7; 192/93 A

(57) ABSTRACT

A motor applies torque to a ball and ramp actuator element generating thrust that is transferred thru a bearing from the stationary actuator to the rotating clutch pack elements of a marine transmission.

### CONTINUATION-IN-PART APPLICATION

This application presents improvements on application Ser. No. 11/364,783 Docket New Case Ready for Examination titled Motor driven ball and ramp clutching system for a marine transmission.

Background of the invention is covered by application Ser. No. 11/364,783.

### BRIEF SUMMARY OF THE INVENTION

A marine transmission may require high level clutch torque for full engine power or lower level varying torque for clutch modulation when trolling to provide constant propeller speed with variation in engine input speed or clutch torque. Application Ser. No. 11/364,783 utilizes a ball ramp thrust actuator to generate clutch engagement pressure. The use of three balls assures equal ball loading distribution. Significant surface stresses and deformations between the ball and ramp spherical and curved surfaces may affect smooth movement and action efficiency during trolling, in particular as minute ramp rotations are required to maintain constant propeller speed. The electric motor operates in a stalled or “torque only” mode. Although the motor may be used continuously energized it is advantageous from a standpoint of motor life and motor heat dissipation to de-energize the motor during high torque operation required at vessel full power and speed.

One purpose of the improvements is to allow continuous clutch engagement by mechanical overlock for vessel full power, electric motor de-energized. Another purpose is to lower the ball and ramp contact stresses and improve efficiency during the trolling mode.

### BRIEF DESCRIPTION OF THE DRAWINGS

FIG. 6 shows how two reversible motors may engage or release either clutch when the teeth on the rotatable circular member of the forward clutch mesh with the teeth on the rotatable circular member of the reverse clutch.

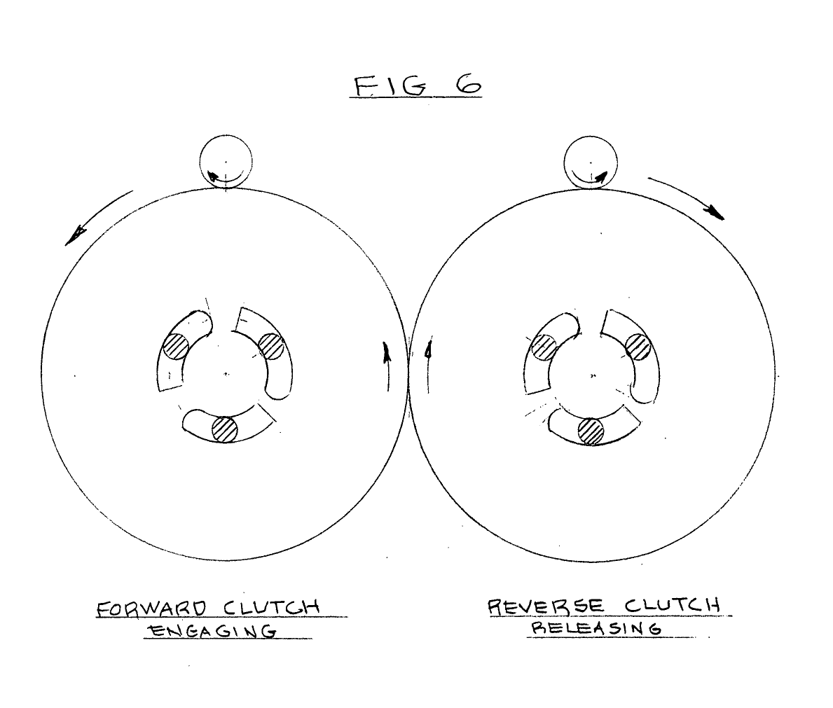

FIG. 7 is a longitudinal section of a means used to allow overlocked engagement of either the forward or reverse clutch and in addition accommodate clutch plate wear. The electric motor may be de-energized. FIG. 7 uses cylindrical rollers mounted on anti friction bearings to improve sliding action and reduce contact stresses with the ramp surfaces.

FIG. 8 provides mechanical overlock ramp engagement using balls and a worm pinion instead of a conventional gear pinion. The worm may sustain the position of the rotatable circular member by preventing back drive. The electric motor may be de-energized. Clutch plate wear is accommodated. FIG. 8 also describes ramp angles required for release, plate engagement, torque load and overlock.

### DETAILED DESCRIPTION OF THE INVENTION

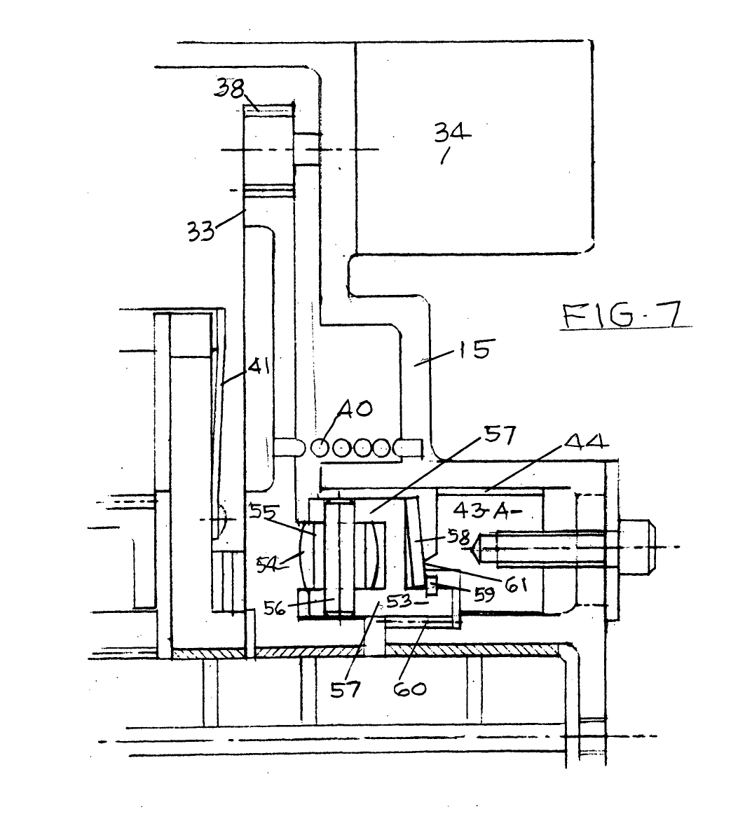

Referring to FIG. 7, electric motor 34 when energized drives pinion 38 meshing with teeth on rotatable circular member 33.

Member 33 has a plurality of arcuate recesses each recess having multiple ramp angles allowing clutch release, clutch engagement, clutch torque generation and clutch overlock. Overlock may be a negative angle. Annular support member 53 has splines 60 that mesh slidably with splines on stationary end cover housing 15 to allow axial movement of member 53. Arms 57 extend from support member 53 to contain and support curved roller assemblies consisting each of a roller 54 anti friction bearing 55 and pin 56.

Support member 53 also supports a Belleville spring 58 held in a pre-loaded condition by snap ring 59. Spring 58 is held in contact with annular protrusion 61 on adjustable element 43-A by clutch release spring 41 when the clutch is released.

When the clutch is engaged to maximum torque, the clamping force reacts to further compress the Belleville spring 58 away from snap ring 59. Spring 58 then compensates for clutch plate wear during ramp overlooked engagement position. The electric motor 34 is then de-energized. Release spring 40 acts together with spring 41 to rotate the circular member 33 to a neutral released position at disengagement.

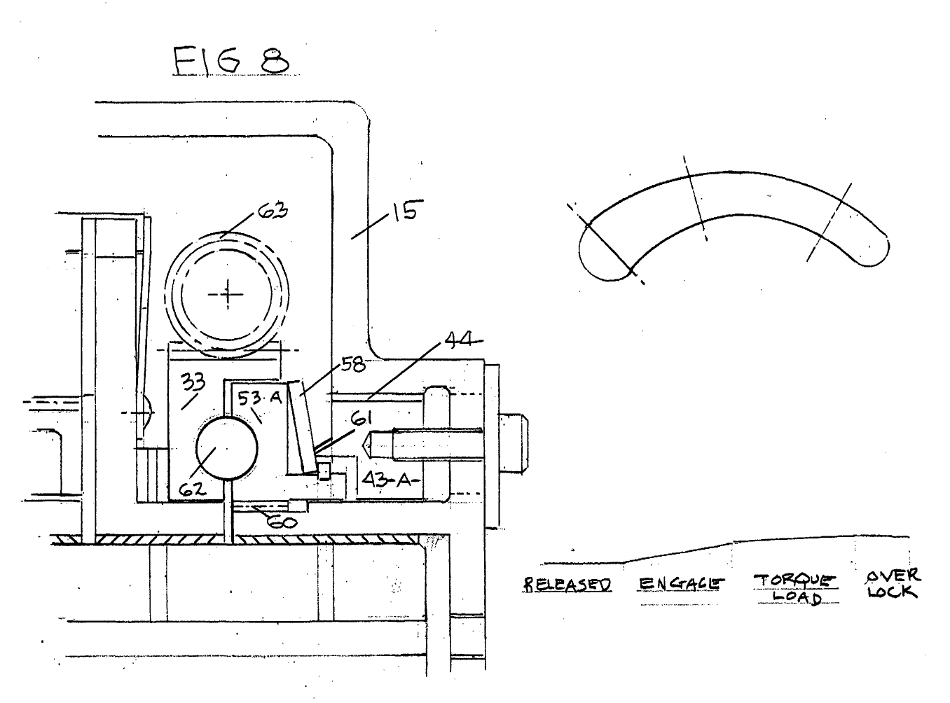

Refer to FIG. 8.

FIG. 8 is a longitudinal section of another means to allow overlooked engagement of either the forward or reverse clutch. It acts also to accommodate plate wear. It uses the ball ramp design of application Ser. No. 11/364,783. FIG. 8 utilizes a self locking worm 13, one in which the gear 33 cannot backdrive the worm 63. Very high reduction ratios can be achieved allowing the use of a smaller electric motor.

The arcuate recesses may be in both the rotatable member 33 and the non-rotatable member 53A providing a greater axial travel to rotational travel ratio than that of FIG. 7. Spline 60 Belleville spring 58 snap ring 59 and adjustable element 43A act in the same manner as FIG. 7 to allow overlooked engagement and compensation for clutch plate wear. The electric motor is again de-energized in this mode. FIG. 8 also shows that ramp angles may be flat for release, steep for clutch plates engagement, low for torque load, and possibly negative for overlock.

I claim:

1. A ball ramp clutch for a marine transmission comprising a combination:
An input member.
An output member.
A first circular member disposed to prevent rotation, but to allow axial movement and defining a first plurality of arcuate recesses. A first circular member supporting a pre-loaded spring which is further compressed during clutch engagement.
A second rotatable circular member disposed adjacent to the first circular member and defining a second set of arcuate recesses.
A plurality of load transferring members disposed in said recesses.
A friction clutch pack assembly having a plurality of friction discs secured for rotation with said input member and a mating interleaved plurality of friction discs secured for rotation with said output member.
Rotating means for the second circular ramp member to produce an axial force that is carried through a thrust bearing to apply compressive force to said friction disc pack and transfer power from said input member to said output member.
A motor to provide turning effort to rotate the second circular member.
A driving means between the motor and the second circular member.

2. The ball ramp clutch of claim 1 whereby an electric motor is energized to produce turning effort to cause selective friction clutch engagement or disengagement through a drive means.

3. The ball ramp clutch of claim 1 in which the ramp angles may be described as flat for clutch released, steep for initial engagement taking up plate release, low for torque generation and negative for overlock after engagement.

4. The ball ramp clutch of claim 1 wherein the preloaded spring is of Belleville design and is retained pre-loaded by a snap ring.

5. The ball ramp clutch of claim 1 where an annular protrusion on the adjustable element contacts the Belleville spring during clutch engagement and assumes the engagement reactionary force.

6. The ball ramp clutch of claim 1 in which the drive means between the motor and second circular member includes a self locking worm pinion meshing with gear teeth on the second rotatable circular member.

7. A ball ramp clutch for a marine transmission comprising a combination:
An input member.
An output member.
A first annular support member disposes to prevent rotation but to allow axial movement having extended arms each arm supporting and containing a roller assembly consisting of a roller, anti friction bearing and stationary pin.
A first annular circular member supporting a pre-loaded spring which is further compressed during clutch engagement.
A second rotatable circular member disposed adjacent to the first annular circular member and defining a set of arcuate recesses contacting the roller assemblies.
A friction clutch pack assembly having a plurality of friction discs secured for rotation with said input member and a mating interleaved plurality of friction discs secured for rotation with said output member.
Rotating means for the second circular ramp member to produce an axial force that is carried through a thrust bearing to apply compressive force to said friction disc pack and transfer power from said input member to said output member.
A motor to provide turning effort to rotate the second circular member.
A driving means between the motor and the second circular member.

8. The ball ramp clutch of claim 7 whereby an electric motor is energized to produce turning effort to cause selective friction clutch engagement or disengagement through a drive means.

9. The ball ramp clutch of claim 7 wherein the pre-loaded spring is of Belleville design and is restrained by a snap ring.

10. The ball ramp clutch of claim 7 where an annular protrusion on the adjustable element contacts the Belleville spring during clutch engagement and assumes the engagement reactionary force.
